(19) United States
(12) Patent Application Publication
(10) Pub. No.: US 2010/0082722 A1
(43) Pub. Date: Apr. 1, 2010

(54) Methods and Apparatuses for Detection and Estimation with Fast Fourier Transform (FFT) in Orthogonal Frequency Division Multiplexing (OFDM) Communication Systems

(76) Inventors: Mohanned O. Sinnokrot, Atlanta, GA (US); Dukhyun Kim, Marietta, GA (US)

Correspondence Address: SUTHERLAND ASBILL & BRENNAN LLP, 999 PEACHTREE STREET, N.E., ATLANTA, GA, 30309, US

(21) Appl. No.: 12/238,838

(22) Filed: Sep. 26, 2008

(51) Int. Cl. G06F 17/14

(52) U.S. Cl. 708/404

(57) ABSTRACT

Methods and apparatuses are provided for a fast Fourier transform (FFT)/inverse fast Fourier transform (IFFT) architecture that not only allows for efficient computation of N-point FFT/IFFT transform (N=2ⁿ), but also allows for efficient reuse of the multipliers and delay blocks for efficient implementation of signal energy detection and autocorrelation of length or period 2^{p}, where pε{0, 1, . . . , log₂(N)−1}. Signal energy detection and autocorrelation may then used for received energy measurement, frame synchronization, including packet detection or symbol timing, and carrier frequency offset estimation.

### FIELD OF THE INVENTION

Aspects of the invention relate generally to orthogonal frequency division multiplexing (OFDM) communication systems, and more particularly, to energy detection, frame synchronization, and carrier frequency offset estimation in OFDM communications systems.

### BACKGROUND OF THE INVENTION

An OFDM signal is generated as the sum of subcarriers that are modulated by the complex information symbols to be transmitted. The data is transmitted in parallel on orthogonal subcarriers, which are made orthogonal to each other by separating them in frequency by a multiple of the symbol frequency 1/T. The OFDM signal is then given by equation (1) below, as follows:

$$s ( t ) = {\sum }_{k = 0}^{N - 1} {d}_{k} exp ( j2π kt / T ) , \qquad ( 1 )$$

where dₖ are the complex information symbols to be transmitted and T is the OFDM symbol period. The complex baseband OFDM signal is the inverse discrete Fourier transform (DFT) of N input data symbols, which is implemented efficiently using the inverse fast Fourier transform (FFT).

An essential part of the receiver is frame synchronization, and frequency offset estimation and correction. Frame synchronization refers to packet detection, which is estimating the start of the preamble of the incoming data packet, and symbol timing, which is finding the precise boundaries of individual OFDM symbols (i.e., start and end of each OFDM symbol). Packet detection and symbol timing algorithms rely on the short and long preambles, which are known sequences at the receiver.

FIG. 1 illustrates a typical IEEE 802.11a/g or IEEE 802.11n (legacy mode) protocol that includes a short preamble, a long preamble, signal field, and data field. In FIG. 1, the short preamble comprises ten identical short sections, t1 through t10, where each section is 0.8 us in duration. For a sampling frequency of 20 MHz, each short section consists of 16 OFDM samples. The short preamble has a duration of 8.0 us. The long preamble comprises a guard interval (GI2) and two identical long sections, T1 and T2, where each long section is 3.2 us in duration and consists of 64 samples. The guard interval GI2 is 1.6 us in duration and consists of 32 samples, that are identical to the last 32 samples of T1 (or T2). Similar to the short preamble, the long preamble has a duration of 8.0 us.

A standard radix-2³ single-path delay feedback (SDF) architecture for 128-point data path is shown in FIG. 2. The radix-2³ SDF architecture has three types of butterflies: Type I, Type II and Type III, which are shown in FIG. 3, FIG. 4 and FIG. 5, respectively. The seven butterflies in FIG. 2 are labeled BF A through BF G. The Type I and Type II butterflies involve only addition and negation, while the Type III butterfly also involves constant multiplication by 1/\sqrt{2}. The operations of the Type I butterfly are a subset of the operations of the Type II butterfly, which in turn are a subset of the operations of the Type III butterfly. The arithmetic operation performed by the three butterfly types is determined by the control signal(s) S₁, S₂, and/or S₃, as shown in FIG. 3-5. The cascade of the three types of butterflies allows for efficient implementation of an 8-point FFT, which is implemented using the radix-2 butterfly structure. The cascade of the three butterflies is known as radix-2³ implementation. The radix-2³ stage is repeated to obtain larger length FFT transforms with a complex multiplier preceding each radix-2³ stage.

### SUMMARY OF THE INVENTION

According to an example embodiment of the invention, there may be an apparatus for Detection and Estimation with Fast Fourier Transform (FFT) in Orthogonal Frequency Division Multiplexing (OFDM) Communication Systems. The apparatus may include a plurality of butterfly operators that are operative with respective delay blocks in calculating a Fourier transform of a signal input, at least one complex multiplier, and a plurality of multiplexers. The plurality of multiplexers may be configured to selectively operate the at least one complex multiplier to (i) calculate the Fourier transform of the signal input using the plurality of butterfly operators, or (ii) calculate one or both of an energy signal based upon the signal input, or at least one autocorrelation signal based upon the signal input and at least one delayed input from at least one delay block.

According to another example embodiment of the invention, there may be a method for Detection and Estimation with Fast Fourier Transform (FFT) in Orthogonal Frequency Division Multiplexing (OFDM) Communication Systems. The method may include providing a plurality of butterfly operators that are operative with respective delay blocks in calculating a Fourier transform of a signal input, providing at least one complex multiplier, and configuring a plurality of multiplexers to selectively operate the at least one complex multiplier to (i) calculate the Fourier transform of the signal input using the plurality of butterfly operators, or (ii) calculate one or both of an energy signal based upon the signal input, or at least one autocorrelation signal based upon the signal input and at least one delayed input from at least one delay block.

### BRIEF DESCRIPTION OF THE DRAWINGS

Reference will now be made to the accompanying drawings, which are not necessarily drawn to scale, and wherein:

FIG. 1 illustrates a conventional IEEE 802.11a/g or IEEE 802.11n (legacy mode) protocol that includes a short preamble, a long preamble, signal field, and data fields.

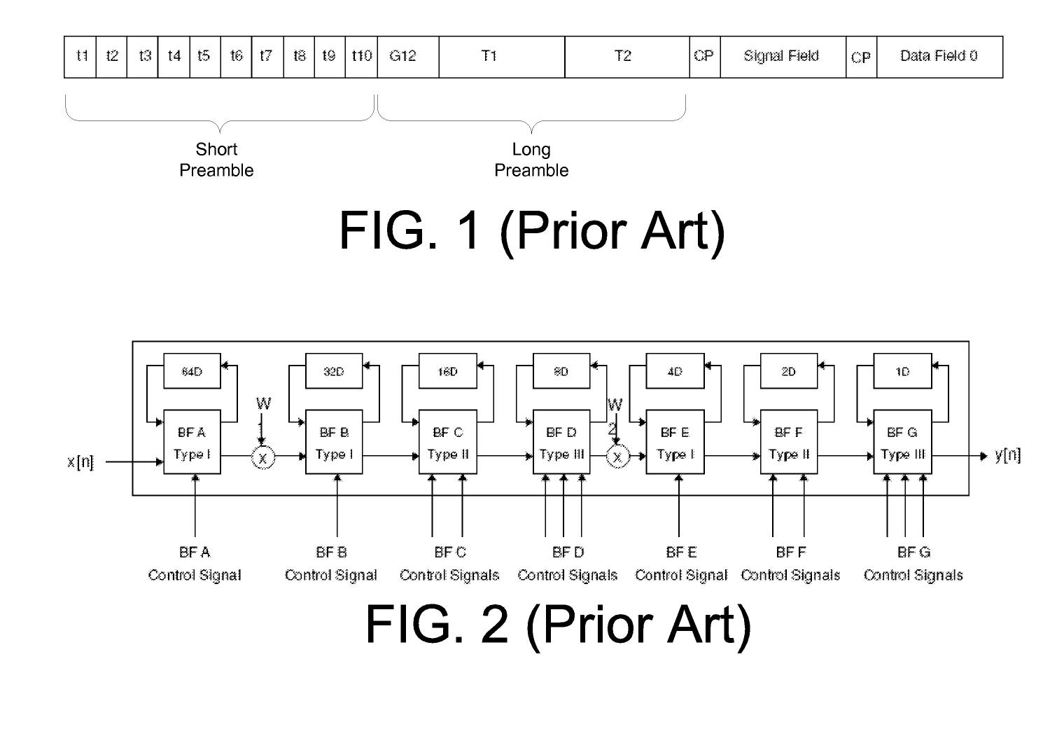

FIG. 2 illustrates conventional radix-2³ single-path delay feedback (SDF) architecture for 128-point data path.

FIG. 3 illustrates a conventional Type I butterfly architecture.

FIG. 4 illustrates a conventional Type II butterfly architecture.

FIG. 5 illustrates a conventional Type III butterfly architecture.

FIG. 6 illustrates an example embodiment of an architecture that supports a 128-point FFT/IFFT using a radix-2³ single-path delay feedback architecture, according to an example embodiment of the invention.

FIGS. 7 and 8 illustrate an extended architecture capable of performing energy detection and/or autocorrelation for use in determining received energy measurement, frame synchronization and carrier frequency offset estimation, according to an example embodiment of the invention.

### DETAILED DESCRIPTION

Embodiments of the present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the invention may be directed towards a fast Fourier transform (FFT)/inverse FFT architecture that not only allows for efficient computation of N-point FFT/IFFT transform (N=2ⁿ), but also allows for efficient reuse of the multipliers and delay blocks (e.g., tap delay lines) for efficient implementation of signal energy detection and autocorrelation of length or period 2^{p}, where pε{0, 1, . . . , log²(N)−1}. The signal energy detection and autocorrelation may be used for the implementation of frame synchronization and carrier frequency offset estimation. Frame synchronization may include one or both of packet detection (“coarse timing”) or symbol detection (“fine timing”). It should be appreciated that example embodiments of the FFT/IFFT architecture can be implemented for a general 2^{m} radix and for general delay architectures that include, but are not limited to, the single-path delay feedback (SDF), single-path delay commutator (SDC) and multi-path delay commutator (MDC) architectures.

A first aspect of the invention may be directed towards a flexible architecture for computing N-point FFT/IFFT, where flexibility may be defined in terms of supporting different power-of-two FFT/IFFT lengths, using different power-of-two radix values, and using different delay architectures, according to an example embodiment of the invention. A second aspect of the invention may be directed towards an efficient and flexible architecture for computing the energy of a complex baseband OFDM signal. Efficiency may be defined in terms of reusing the complex multipliers and delay blocks (e.g., tap delay lines) of the FFT/IFFT architecture for the computation of the OFDM signal's energy. Flexibility may be defined in terms of supporting different window lengths for computing the energy such that the window length is 2^{p}, where pε{0, 1, . . . , log₂(N)−1}.

A third aspect of the invention may be directed towards an efficient and flexible architecture for computing the autocorrelation of a complex OFDM signal. Efficiency may be defined in terms of reusing the complex multipliers and delay blocks (e.g., tap delay lines) of the FFT/IFFT architecture. Similarly, flexibility may be defined in terms of supporting different period lengths for computing the autocorrelation such that the period length is 2^{p}, where pε{0, 1, . . . , log²(N)−1}. A fourth aspect of the invention may be directed towards an architecture for computing the received signal strength indicator (RSSI). A fifth aspect of the invention may be directed towards an architecture for packet detection, which may also be referred to as coarse timing. A sixth aspect of the invention may be directed towards an architecture for coarse estimation of the carrier frequency offset. A seventh aspect of the invention may be directed towards an architecture for symbol timing, which is also referred to as fine timing. An eighth object of the invention may be directed towards an architecture for fine estimation of the carrier frequency offset. These and other aspects of embodiments of the invention will be appreciated by those of ordinary skill in the art.

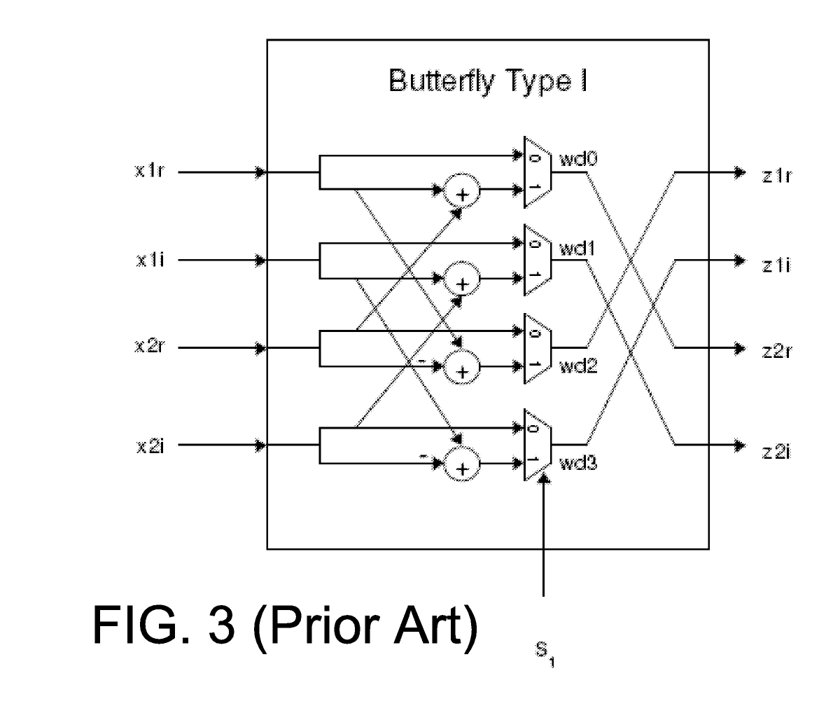

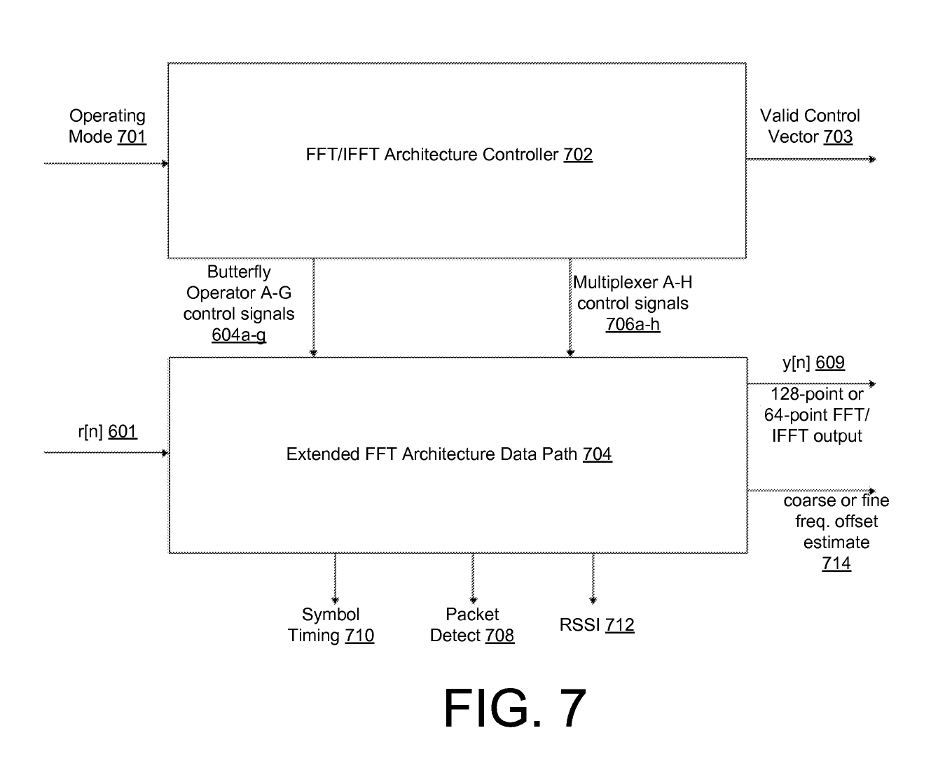

FIG. 6 illustrates an example embodiment of an architecture that supports a 128-point FFT/IFFT using a radix-2³ single-path delay feedback architecture, according to an example embodiment of the invention. In general, the architecture of FIG. 6 extends the architecture of FIG. 2 such that existing delay blocks (e.g., tap delay lines) and multipliers of the FFT/IFFT may likewise be utilized with additional multiplexers to route the data and intermediate values to perform energy detection and/or autocorrelation that may support additional functionality associated with received energy measurement, packet detection (coarse timing), symbol timing (fine timing), and coarse and fine carrier frequency offset estimation.

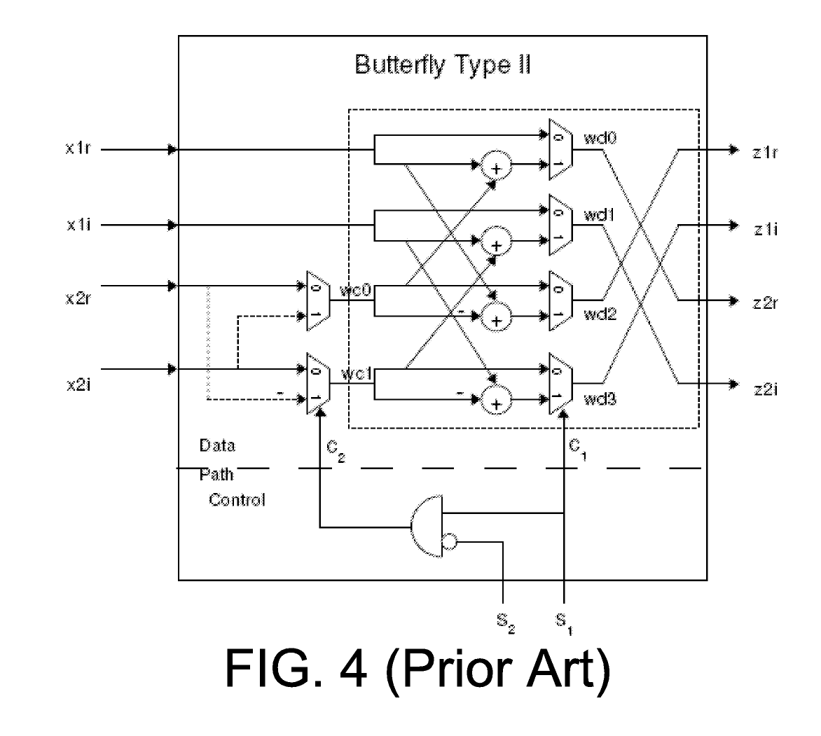

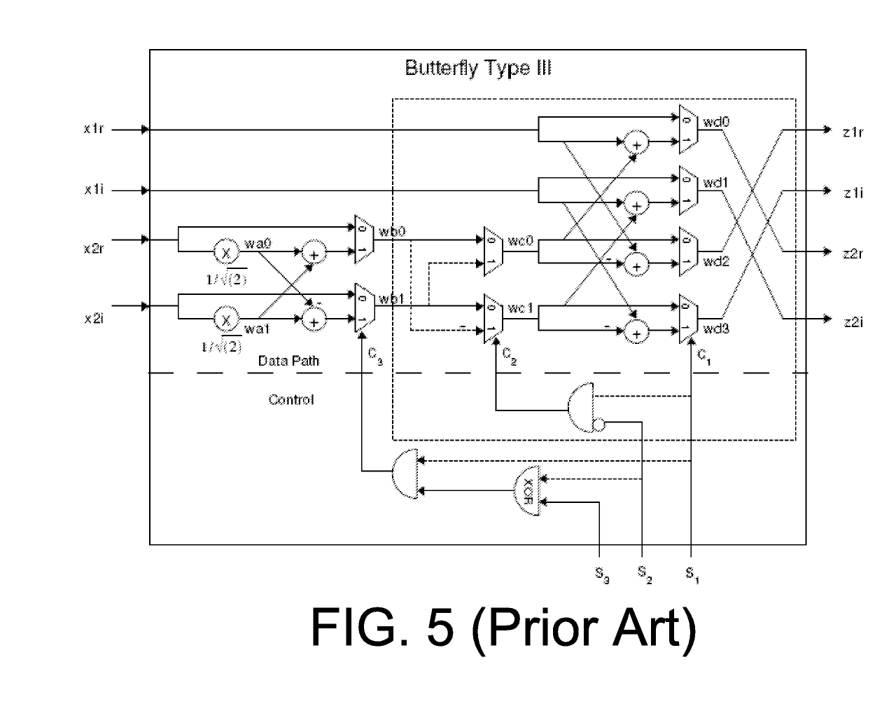

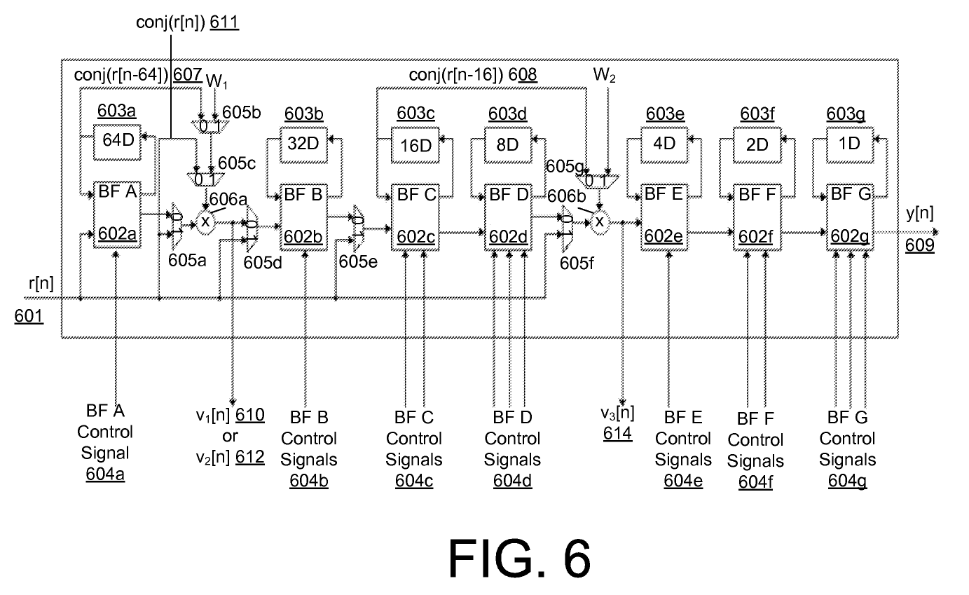

Turning now to FIG. 6, there may be a plurality of butterfly operators 602a-g (i.e., BF A-G). The butterfly operators 602a-g may be operative to perform constituent transform operations of a fast Fourier transform (FFT) or an inverse fast Fourier transform (IFFT), according to an example embodiment of the invention. As shown in FIG. 6, the butterfly operator 602a may be a Type I butterfly operator. Butterfly operators 602b-d may be Type I, Type II, and Type III butterfly operators, respectively. Similarly, butterfly operators 602-e-g may be Type I, Type II, and Type III butterfly operators, respectively. According to an example embodiment of the invention, the Type I, Type II, and III butterfly operators may be in accordance with, or otherwise similar to, those illustrated in FIGS. 3, 4, and 5, respectively. The operations of the butterfly operators 602a-g may be configured using respective control signals 604a-g. Control signals 604a, 604b, 604e may each include a single control signal for controlling their respective type I butterfly operators 602a, 602b, 602e. Control signals 604c, 604f may each include two control signals for controlling their respective Type II butterfly operators 602c, 602f. Control signals 604d, 604g may each include three control signals for controlling their respective Type III butterfly operators 602d, 604g.

Each of the butterfly operators 602a-602g may operate with a respective delay block 603a-603g, which may also be referred to as tap delay lines according to an example embodiment of the invention. The delay blocks 603a-603g may be implemented using respective flip-flops, resistors, or other memory elements, according to an example embodiment of the invention. As shown in the FIG. 6, the delay blocks 603a-603g may provide delays of 64, 32, 16, 8, 4, 2, and 1 sample or sampling period or clock period, respectively, according to an example embodiment of the invention. Other variations of the delay for the delay blocks 603a-603g may be available without departing from example embodiments of the invention.

In FIG. 6, there may also be a plurality of multiplexers (MUXs) 605a-605f (i.e., MUXs A-F). The plurality of multiplexers 605a-f may be configured to utilize the complex multipliers 606a and 606b, as well as the butterfly operators 602a-g and delay blocks 603a-g, in computing a multi-point (e.g., 128-point or 64-point) FFT/IFFT output y[n] 609 based upon a received OFDM signal input r[n] 601. Additionally, the plurality of multiplexers 605a-f may be configured to utilize the complex multipliers 606a and 606b, as well as one or more of the butterfly operators 602a-g and delay blocks 603a-g, in providing signal energy detection and autocorrelation that may be used for an implementation of frame synchronization and carrier frequency offset estimation. By way of example, the multiplexers 605a-d may allow for the reuse of complex multiplier 606a and delay block 603a for signal energy detection and autocorrelation of length or period 2^{p}, where pε{0, 1, . . . , log₂(N)−1}. Indeed, as described herein, the multiplexers 605a-d can be configured in order to generate an energy signal v₁ [n] 610 representative of the energy of the OFDM signal input r[n] 601, or a first autocorrelation signal v₂[n] 612 associated with the OFDM signal input r[n] 601 and a first delayed OFDM signal (e.g., conj(r[n−64]) 607 provided by delay block 603a). Similarly, the multiplexers 605e-g may allow for the reuse of complex multiplier 606b for autocorrelation of length or period 2^{p}, where pε{0, 1, . . . , log₂(N)−1}. For example, as described herein, the multiplexers 605e-g can be configured in order to generate a second autocorrelation signal v₃[n] 614 associated with the OFDM signal input r[n] 601 and a second delayed OFDM signal (e.g., conj(r[n−16]) 608 provided by delay block 603c). The generated signals v₁[n] 610, v₂[n] 612, and v₃[n] 614 may then be utilized according to an extended architecture for energy measurement, frame synchronization, and/or carrier frequency offset estimation.

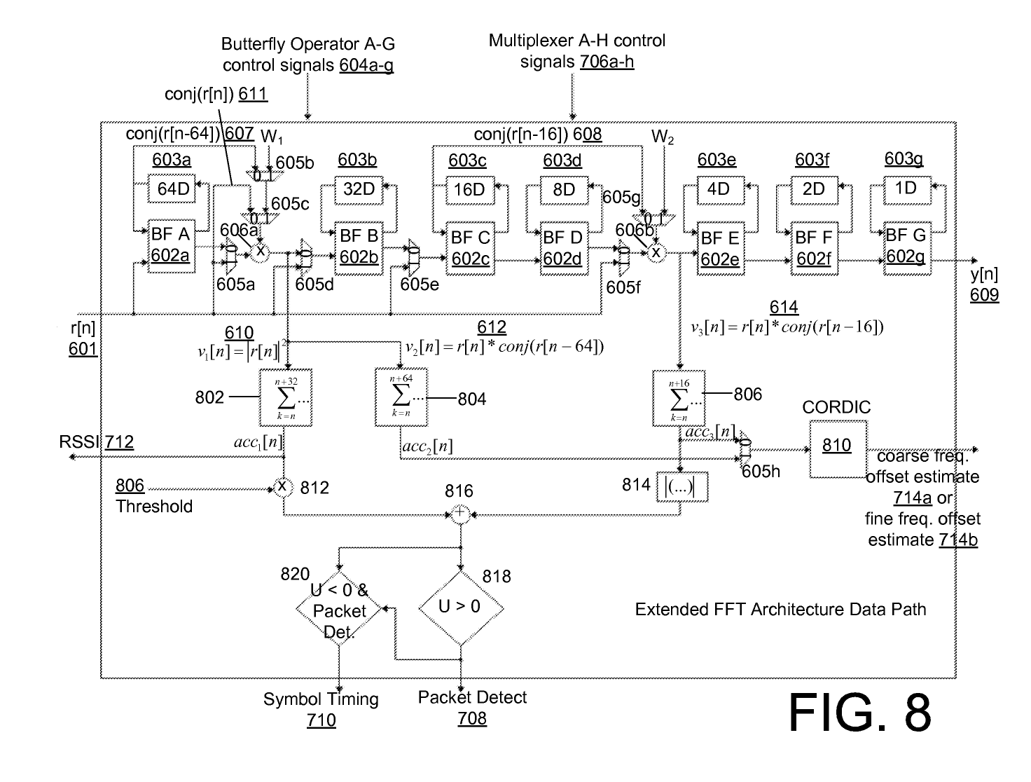

FIGS. 7 and 8 illustrate an extended architecture capable of performing energy detection and/or autocorrelation for use in determining received energy measurement, frame synchronization (e.g., packet detection, symbol timing), and carrier frequency offset estimation, including coarse and fine frequency offset estimation, according to an example embodiment of the invention. It will be appreciated that FIGS. 7 and 8 have been illustrated for a specific case of signal energy detection window length of 32 and autocorrelation period of 16 and 64. However, other example embodiments of the invention may utilize other signal energy detection window lengths and autocorrelation periods without departing from example embodiments of the invention.

FIG. 7 illustrates example points of control between an FFT/IFFT Architecture Controller 702 and an extended FFT/IFFT architecture data path 704. Given an operating mode 701 (e.g., 64-point/128-point FFT mode, packet detection, symbol timing, fine/coarse frequency estimation mode, etc.), the controller 702 may generate the butterfly operator A-G control signals 604a-g and multiplexer A-H control signals 706a-h to the data path 704. Additionally, the controller 702 may generate a valid control vector 703, which indicates when the different output signals (e.g., output y[n] 609) from the data path 704 are valid.

FIG. 8 illustrates an example architecture of an extended data path, according to an example embodiment of the invention. Similar to FIG. 6, the extended data path includes butterfly operators 602a-g, delay blocks 603a-g, and multiplexers 605a-g. However, FIG. 8 also includes the following additional blocks: three accumulators 802, 804, and 806 for accumulating 32, 64 and 16 samples, respectively; a magnitude or absolute value block 814; an adder 816; a complex multiplier 812; two comparators 818, 820; a multiplexer 605h, and a phase estimation block 810 for computing the coarse or fine frequency offset 714. In an example embodiment of the invention, the phase estimation block 810 may be a CORDIC block, although another computational block may be utilized for phase measurement and/or estimation, according to an example embodiment of the invention.

As shown by FIGS. 7 and 8, the extended data path may be operative to perform one or more of the following: (A) 128-point FFT and inverse FFT, (B) 64-point FFT and inverse FFT, (C) packet detection, (D) received energy measurement, (E) symbol timing, (F) coarse frequency offset estimation, and (G) fine frequency offset estimation. It will be appreciated that while example algorithms are described herein for received energy measurement, packet detection, symbol timing, coarse frequency offset estimation, and fine frequency offset estimation, other variations of the algorithms are possible without departing from example embodiments of the invention.

A. 128-Point FFT/IFFT Operation

Referring to FIGS. 7 and 8, for 128-point FFT/IFFT operation in accordance with an example embodiment of the invention, the control signals 706a-h for the multiplexers 605a-h (i.e., MUXs A-H) may be given by the control vector {0, 1, 1, 0, 0, 0, 1, x}, where “0” or “1” means the designated multiplexer 605a-h passes the signal connected to the “zero” port or “one” port, respectively and “x” means the position of the designated multiplexer does not matter. In accordance with the control vector, multiplexer 605a may be set in the “0” position; multiplexers 605b and 605c may be set in the “1” position; multiplexers 605d, 605e, and 605f may be set in the “0” position; multiplexer 605g may be set in the “1” position; and multiplexer 605h may be set in any position. The 128-point FFT and IFFT may be computed in 2N−1+L cycles, where N=128, and where L is additional latency due to pipelining in the data path 704. The control signals 604a-g for butterfly operators 602a-g for the 128-point FFT/IFFT can be determined by one of ordinary skill in the art, for example, from He and M. Torkelson, “Designing pipeline FFT processors for OFDM (de)modulation,” Proc. of URSI Int. Symp. on Signals, Systems, and Electronics (ISSSE 98), 1998, pp. 257-262. A valid control vector 703 is then generated by the controller to indicate that the computation has been performed and that the output y[n] 609 samples are the forward or inverse FFT of the input r[n] 601.

B. 64-Point FFT/IFFT Operation

According to an example embodiment of the invention, the architecture of FIG. may likewise be utilized for 64-point FFT/IFFT operation. For 64-point FFT/IFFT operation, the control signals 706a-h for the multiplexers 605a-h (e.g., MUXs A through H) may be given by the control vector {x, x, x, 1, 0, 0, 1, x}. In accordance with the control vector, the positions of multiplexers 605a, 605b, and 605c do not matter, and thus, may be set in any position; multiplexer 605d may be set in the “1” position; multiplexers 605e, 605f may be set in the “0” position; multiplexer 605g may be set in the “1” position; and multiplexer 605h may be set in any position. The 64-point FFT and inverse FFT may be computed in 2N−1+L cycles, where N=64, and where L is additional latency due to pipelining in the data path. The control signals 604a-g for the different butterfly operators 602a-g for 64-point FFT may be a subset of the control signals for 128-point FFT/IFFT and can be determined by one of ordinary skill in the art, for example, from He and M. Torkelson, “Designing pipeline FFT processors for OFDM (de)modulation,” Proc. of URSI Int. Symp. on Signals, Systems, and Electronics (ISSSE 98), 1998, pp. 257-262. Similar to the 128-point transform, only the basic architecture may be utilized during the computation of 64-point FFT or inverse FFT.

C. Packet Detection (Coarse Timing)

According to an example embodiment of the invention, the extended architecture of FIGS. 7 and 8 may be operable for packet detection algorithm in accordance with a delay and correlate algorithm. Generally, in accordance with the delay and correlate algorithm, the autocorrelation of the input signal may be compared against the input signal's energy. A rise in the autocorrelation above a threshold may be used to indicate a valid detection of packet, which may be a 802.11a/g/n packet or another type of packet, according to an example embodiment of the invention.

For packet detection, the control signals 706a-h for the multiplexers 605a-h are given by the control vector {1, x, 0, x, 1, 1, 0, 0}. The control signals 604a-g for butterfly operators 602a-g are given by an all-zero control vector {{0}, {0}, {0, 0}, {0, 0, 0}, {0}, {0, 0}, {0, 0, 0}}. In general, an all-zero control vector results in the butterfly operators 602a-g passing their respective inputs to the outputs without applying any arithmetic operation involved in transformation of the input. As a result of this configuration, an energy signal v₁[n] 610 and an autocorrelation signal v₃[n] 614 may be provided, as illustrated by equations (2) and (3) below:

v₁[n]=r[n]*conj(r[n])=|r[n]|² (2),

v₃[n]=r[n]*conj(r[n−16]) (3).

The energy signal v₁[n] 610 may be the output by complex multiplier 606a, which multiplies the input r[n] 601 from multiplexer 605a with the conjugate(r[n]) 611 from multiplexer 605c. The autocorrelation signal v₃[n] 614 may be the output of complex multiplier 606b, which multiplies the input r[n] 601 from multiplexer 605f by the delayed conjugate (r[n−16]) input 608 from multiplexer 605g.

The energy signal v₁ [n] 610 and the autocorrelation signal v₃[n] 614 may be provided as inputs to accumulators 802 and 806, respectively. The 32-sample and 16-sample accumulator outputs acc₁[n] and acc₃[n] of accumulators 802, 806 may given by equations (4) and (5) below:

$$\begin{matrix}{acc}_{1} [ n ] = {\sum }_{k = n}^{n + 32} {v}_{1} [ n ] , & ( 4 ) \\ {acc}_{3} [ n ] = {\sum }_{k = n}^{n + 16} {v}_{3} [ n ] . & ( 5 )\end{matrix}$$

The 32-sample accumulator output acc₁[n] may be multiplied by a threshold 806 using multiplier 812 to generate a first intermediate signal. The magnitude of the 16-sample accumulator output acc₃[n] may be determined by the magnitude or absolute value block 814, thereby providing a second intermediate signal. The first and second intermediate signals may then be added by an adder 816 to generate a decision signal “U” for use in determining receipt of a valid packet. The decision signal “U” may be provided as follows:

U=|acc₃[n]|−Threshold*acc₁[n] (6).

If comparator 818 determines that the value of “U” is greater than zero, then a valid packet is detected, and a packet detect signal 708 is generated. It will be appreciated by one of ordinary skill in the art that the above-identified algorithm is only one example embodiment of a packet detection algorithm. By way of example, the comparator 818 may determine whether the second intermediate signal is greater than the first intermediate signal. Likewise, other variations of packet detection algorithms that use different lengths for the autocorrelation period or signal energy are possible. Furthermore, multiple autocorrelations can be implemented to improve the robustness of the algorithm and reduce the probability of a false detection.

D. Received Energy Measurement

According to an example embodiment of the invention, an illustrative received energy measurement algorithm may run in parallel to the packet detection algorithm, or perhaps prior to packet detection algorithm, in the scenario where the received energy measurement is used for automatic gain control. The energy measured at the receiver is usually reported as a quantity termed the received signal strength indicator (RSSI). For received energy measurement, the control signals 706a-h for the multiplexers 605a-h may be given by the control vector {1, x, 0, x, x, x, x, x}. The control signals 604a-g for butterfly operators 602a-g are given by the all-zero control vector {{0}, {0}, {0, 0}, {0, 0, 0}, {0}, {0, 0}, {0, 0, 0}}

As a result of this configuration, an energy signal v₁[n] 610 may be provided, as similarly discussed above. The energy signal v₁[n] 610 may be the output by complex multiplier 606a, which multiplies the input r[n] 601 received from multiplexer 605a with the conjugate(r[n]) input 611 received from multiplexer 605c. In an alternative embodiment of the invention, the energy signal may be determined by applying a magnitude or absolute value block to the squared product of the input r[n] 601. The energy signal v₁[n] 610 may be provided as an input to accumulator 802, which in turn generates a 32-sample accumulator output acc₁[n], according to an example embodiment of the invention. The received signal strength indicator (RSSI) 712 may be the accumulator output acc₁ [n], or otherwise derived from the accumulator output acc₁[n], according to an example embodiment of the invention. It will be appreciated that variations of the above-described configuration are possible.

E. Coarse Carrier Frequency Offset Estimation

According to an example embodiment of the invention, an illustrative coarse frequency offset estimate algorithm may run in parallel to the packet detection algorithm, and accordingly, the control signals 706a-h for the multiplexers 605a-h may be the same as for packet detection, and are given by the control vector {1, x, 0, x, 1, 1, 0, 0}. The control signals 604a-g for butterfly operators 602a-g may be given by the all-zero control vector {{0}, {0}, {0, 0}, {0, 0, 0}, {0}, {0, 0}, {0, 0, 0}. Once a packet is successfully detected, the accumulator 806 output acc₃[n] may be used to estimate the carrier frequency offset. In the absence of noise, the accumulator signal acc₃ [n] may be given by equation (7) below:

$${acc}_{3} [ n ] = {\sum }_{k = n}^{n + 16} {v}_{3} [ n ] = exp ( - j2π {f}_{Δ} {D}_{1} T ) {\sum }_{k = n}^{n + 16} {\vert s [ n ] \vert}^{2} , \qquad ( 7 )$$

where f_{Δ} may be the carrier frequency offset, T may be the sampling period, s[n] may be the transmitted signal, and D₁=16 may be the delay between identical samples of the two repeated sections of a short preamble. The coarse frequency offset estimate may then be given by:

\hat{f}_{Δ}=−1/(2πDT)∠acc₃[n] (8),

where ∠x may the operator that takes the angle of the argument x, which may be performed by the phase estimation block 810 (e.g., CORDIC). Once the phase estimation block 810 calculates the phase of the input signal acc₃ [n], a valid control vector 703 may be generated by the controller 702 to indicate that the computation has been performed and that the frequency error estimate 714a produced by the phase estimation block 810 may be used for correction.

F. Symbol Timing (Fine Timing)

According to an example embodiment of the invention, an illustrative symbol timing algorithm may be based on delay and correlate algorithm. In general, during symbol timing, the autocorrelation of the input signal r[n] may be compared against the signal's energy and the fall in the autocorrelation below a threshold may be used to indicate a transition from the short preamble to the long preamble in a packet such as a 802.11a/g/n packet.

For symbol timing, the control signals 706a-h for the multiplexers 605a-h may be the same as for the packet detection and coarse frequency offset estimation, and may be given by {1, x, 0, x, 1, 1, 0, 0}. The control signals 604a-g for butterfly operators 602a-g may be given by the all-zero control vector {{0}, {0}, {0, 0}, {0, 0, 0}, {0}, {0, 0}, {0, 0, 0}}. The symbol timing algorithm may be substantially the same as the packet detection algorithm described herein, except that symbol timing is indicated by a fall in the autocorrelation function, as indicated by a value of the decision signal “U” that is less than zero. Accordingly, as shown by comparator 820, if the decision signal “U” is less than zero and a packet detect signal 708 has previously been generated, then a symbol timing signal 710 may be generated.

It will be appreciated that many variations of the symbol timing algorithm may be possible. For example, other variations of packet detection algorithms that use different lengths for the autocorrelation period are possible.

G. Fine Carrier Frequency Offset Estimation

In accordance with an example embodiment of the invention, an illustrative fine carrier frequency offset estimation algorithm may be enabled once symbol timing is established. For fine frequency offset estimation, the control signals 706a-h for the multiplexers 605a-h may be given by the control vector {1, 0, 1, x, x, x, x, 1}. The control signals 604a-g for butterfly operators 602a-g may be given by the all-zero control vector {{0}, {0}, {0, 0}, {0, 0, 0}, {0}, {0, 0}, {0, 0, 0}}.

In this configuration, the autocorrelation signal v₂[n] 612 may be the output of complex multiplier 606a, which multiplies the input r[n] 601 from multiplexer 605a by the delayed conjugate(r[n−64]) input 607 from multiplexers 605b and 605c. The autocorrelation signal v₂[n] 612 may provide as an input to accumulator 804. The accumulator output acc₂ [n] may be used to estimate the carrier frequency offset. In the absence of noise, the accumulator signal acc₂ [n] may be given by:

$${acc}_{2} [ n ] = {\sum }_{k = n}^{n + 64} {v}_{2} [ n ] = exp ( - j2π {f}_{Δ} {D}_{2} T ) {\sum }_{k = n}^{n + 64} {\vert s [ n ] \vert}^{2} . \qquad ( 9 )$$

The fine frequency offset estimate may then be given by:

\hat{ƒ}_{Δ}=−1/(2πD₂T)∠acc₂[n] (10),

where D₂=64 is delay between identical samples of T1 and T2, and ∠x may the operator that takes the angle of the argument x, which is performed by the phase estimation block 810 (e.g., CORDIC). Once the phase estimation block 810 calculates the phase of the input signal acc₂[n], the valid control vector 703 is generated by the controller 702 to indicate that the computation has been performed and that the frequency error estimate 714b produced by the phase estimation block 810 can be used for correction.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus, comprising:
a plurality of butterfly operators that are operative with respective delay blocks in calculating a Fourier transform of a signal input;
at least one complex multiplier; and
a plurality of multiplexers that are configured to selectively operate the at least one complex multiplier to (i) calculate the Fourier transform of the signal input using the plurality of butterfly operators, or (ii) calculate one or both of an energy signal based upon the signal input, or at least one autocorrelation signal based upon the signal input and at least one delayed input from at least one delay block.

2. The apparatus of claim 1, wherein the Fourier transform is one or both of a forward fast Fourier transform or a inverse fast Fourier transform.

3. The apparatus of claim 1, wherein the plurality of butterfly operators include radix-2 butterfly operators, and wherein the radix-2 butterfly operators include Type I, Type II, and Type III butterfly operators.

4. The apparatus of claim 1, wherein the signal input is an Orthogonal Frequency Division Multiplexing (OFDM) input.

5. The apparatus of claim 1, wherein the at least one complex multiplier includes a first complex multiplier and a second complex multiplier, wherein the plurality of multiplexers includes a first plurality of multiplexers and a second plurality of multiplexers, wherein the at least one autocorrelation signal includes a first autocorrelation signal based upon the signal input and a first delayed input, and a second autocorrelation signal based upon the signal input and a second delayed input, and wherein:
the first plurality of multiplexers are operative with the first complex multiplier in calculating the energy signal or the first autocorrelation signal; and
the second plurality of multiplexers are operative with the second complex multiplier in calculating the second autocorrelation signal.

6. The apparatus of claim 5, wherein a first delay of the first delayed input is different from a second delay of the second delayed input.

7. The apparatus of claim 1, wherein the plurality of multiplexers are configured to operate at least one complex multiplier to calculate the energy signal, wherein the energy signal is accumulated by an accumulator, wherein an output of the accumulator is utilized to determine a received signal strength indicator (RSSI).

8. The apparatus of claim 1, wherein the plurality of multiplexers are configured to operate at least one complex multiplier to calculate the correlation signal, wherein the correlation signal is accumulated by an accumulator, wherein an output of the accumulator is analyzed by a phase estimation block to determine a carrier frequency offset estimate.

9. The apparatus of claim 1, wherein the plurality of multiplexers are configured to operate at least one complex multiplier to calculate the energy signal and the correlation signal, wherein the energy signal is accumulated by a first accumulator, wherein the energy signal is multiplied by a threshold to generate a first intermediate signal, wherein the autocorrelation signal is accumulated by a second accumulator, wherein a second intermediate signal is a magnitude of an output of the second accumulator, and wherein the first intermediate signal is compared with the second intermediate signal to determine packet detection or symbol timing.

10. The apparatus of claim 1, further comprising an architecture controller, responsive to an operating mode, for generating (i) butterfly operator control signals for operating the plurality of butterfly operators in accordance with the operating mode, and (ii) multiplexer control signals for operating the plurality of multiplexers in accordance with the operating mode.

11. A method, comprising:
providing a plurality of butterfly operators that are operative with respective delay blocks in calculating a Fourier transform of a signal input;
providing at least one complex multiplier; and
configuring a plurality of multiplexers to selectively operate the at least one complex multiplier to (i) calculate the Fourier transform of the signal input using the plurality of butterfly operators, or (ii) calculate one or both of an energy signal based upon the signal input, or at least one autocorrelation signal based upon the signal input and at least one delayed input from at least one delay block.

12. The method of claim 11, wherein calculating the Fourier transform includes calculating one or both of a forward fast Fourier transform or a inverse fast Fourier transform.

13. The method of claim 11, wherein providing the plurality of butterfly operators includes providing a plurality of radix-2 butterfly operators, and wherein the radix-2 butterfly operators include Type I, Type II, and Type III butterfly operators.

14. The method of claim 11, wherein the signal input is an Orthogonal Frequency Division Multiplexing (OFDM) input.

15. The method of claim 11, wherein the at least one complex multiplier includes a first complex multiplier and a second complex multiplier, wherein the plurality of multiplexers includes a first plurality of multiplexers and a second plurality of multiplexers, wherein the at least one autocorrelation signal includes a first autocorrelation signal based upon the signal input and a first delayed input, and a second autocorrelation signal based upon the signal input and a second delayed input, and wherein:
the first plurality of multiplexers are operative with the first complex multiplier in calculating the energy signal or the first autocorrelation signal; and
the second plurality of multiplexers are operative with the second complex multiplier in calculating the second autocorrelation signal.

16. The method of claim 15, wherein a first delay of the first delayed input is different from a second delay of the second delayed input.

17. The method of claim 11, wherein the plurality of multiplexers is configured to operate the complex multiplier to calculate the energy signal, wherein the energy signal is accumulated by an accumulator, wherein an output of the accumulator is utilized to determine a received signal strength indicator (RSSI).

18. The method of claim 11, wherein the plurality of multiplexers is configured to operate the complex multiplier to calculate the correlation signal, wherein the correlation signal is accumulated by an accumulator, wherein an output of the accumulator is analyzed by a phase estimation block to determine a carrier frequency offset estimate.

19. The method of claim 11, wherein the plurality of multiplexers is configured to operate the complex multiplier to calculate the energy signal and the correlation signal, wherein the energy signal is accumulated by a first accumulator, wherein the energy signal is multiplied by a threshold to generate a first intermediate signal, wherein the autocorrelation signal is accumulated by a second accumulator, wherein a second intermediate signal is a magnitude of an output of the second accumulator, and wherein the first intermediate signal is compared with the second intermediate signal to determine packet detection or symbol timing.

20. The method of claim 11, further comprising providing a architecture controller that is responsive to an operating mode for generating (i) butterfly operator control signals for operating the plurality of butterfly operators in accordance with the operating mode, and (ii) multiplexer control signals for operating the plurality of multiplexers in accordance with the operating mode.
